(19) United States
(12) Patent Application Publication
(10) Pub. No.: US 2002/0042780 A1
(43) Pub. Date: Apr. 11, 2002

(54) Method for purchasing an electronic document in a network

(76) Inventor: Ta-Kuang Yang, Taipei (TW)

Correspondence Address: WINSTON HSU, 5F, No. 389, Fu-Ho Road, Taipei Hsein, Yung-Ho City, 234, JP

(21) Appl. No.: 09/972,569

(22) Filed: Oct. 9, 2001

(30) Foreign Application Priority Data
Oct. 5, 2000 (TW) 089120759

(51) Int. Cl. G06F 17/60

(52) U.S. Cl. 705/56

(57) ABSTRACT

A digital rights management server (DRM server) exchanges information with at least one electronic document retail server and at least one terminal. A registration procedure and a purchasing procedure are provided. The registration procedure includes: (a) downloading a reading application program into the terminal, which enables authorization by the DRM server of a legal user and a legal terminal; and (b) the DRM server generating an ID code for the legal user and sending the ID code to be stored in the legal terminal. The purchasing procedure includes: (c) sending a request for a desired electronic document from the terminal to the electronic document retail server, the request including information corresponding to the ID code of the user, with information corresponding to the desired electronic document; (d) the electronic document retail server receiving the request from the user and then generating an order for the DRM server, and the order includes information corresponding to the electronic document without the ID code of the user; (e) the DRM server performing a checking procedure that utilizes the corresponding information of the order after receipt of the order by the DRM server; and (f) upon successful completion of the checking procedure, the DRM server sending a verification message to the user, enabling the user to begin a downloading procedure for downloading the electronic document to the terminal.

### BACKGROUND OF THE INVENTION

1. Field of the Invention

The present invention relates to a method for purchasing an electronic document, and more specifically, to a method for purchasing an electronic document by way of a network.

2. Description of the Prior Art

Traditionally, knowledge has been disseminated by way of the printed word in books, newspapers or magazines. With the advent of radio and TV broadcasting, the spread of information increased dramatically. The development of computer communications and the Internet, presently, enables knowledge and information to be transmitted all over the world at a surprising speed. The development of the Internet has generated many new commercial methods; these new methods have the common characteristic of utilizing the Internet for transaction purposes, which is commonly called electronic commerce. Although it is easy to purchase books by way of electronic commerce, it is not easy to ensure security for the boots.

As indicated above, the concept of an electronic reading device has been provided for the requirements of digitized written words and patterns in books to form electronic books. A consumer can purchase electronic books or documents through a network and download the electronic books to a terminal in which the consumer located, by connecting the terminal to the network. The terminal is called the electronic reading device. Although it is a simple and practical concept to utilize the electronic reading device to purchase the desired electronic books or documents, it is also simple to encounter the problem in which a consumer purchases and reads an electronic book in a legal way, and then transmits or spreads the electronic book to others in an illegal way. Furthermore, problems of privacy for a user to transact electronic commerce over the Internet, and the need to consider the requirements of privacy from obstructing trade of electronic books, must all be considered in the design for a trading procedure of electronic books.

### SUMMARY OF THE INVENTION

It is therefore a primary objective of this invention to provide a method for purchasing an electronic document by way of a network.

The present invention, briefly summarized, discloses a method for purchasing an electronic document in a network using a digital rights management server (DRM server) to excharge information with at least one electronic document retail server and at least one terminal. The method comprises a registration procedure and a purchasing procedure, and the registration procedure comprises: (a) loading a reading application program in the terminal for authorization by the DRM server of a legal user and a legal terminal; (b) the DRM server generating an ID code for the legal user and sending the ID code to be stored in the legal terminal. The purchasing procedure comprises: (c) sending a request for a desired electronic document from the terminal to the electronic document retail server, and the request comprises information corresponding to the ID code of the user, with information corresponding to the desired electronic document; (d) the electronic document retail server receiving the request from the user and then generating an order for the DRM server, and the order includes information corresponding to the electronic document without the ID code of the user; (e) the DRM server performing a checking procedure that utilizes the corresponding information of the order after receipt of the order by the DRM server; and (f) upon successful completion of the checking procedure, the DRM server sending a verification message to the user, enabling the user to begin a download procedure for downloading the electronic document to the terminal.

It is an advantage of the present invention that the electronic document retail server of the electronic document commerce system transmits the commerce order to the DRM server without including the user ID, and cannot affect the subsequent download procedure of the electronic document.

These and other objectives and advantages of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an electronic document commerce system according to the present invention.

FIG. 2 is a functional block diagram of a digital rights management server of the electronic document commerce system according to the present invention.

FIG. 3 is a flow diagram of the electronic document commerce system when performing a registration procedure according to the present invention.

FIG. 4 is a flow diagram of the electronic document commerce system before forming a commerce order according to the present invention.

FIG. 5 is a flow diagram of the digital rights management server after receiving a commerce order according to the present invention.

FIG. 6 is a flow diagram of the electronic document commerce system when downloading an electronic document according to the present invention.

### DETAILED DESCRIPTION OF THE PREFERRED EMBODIMENT

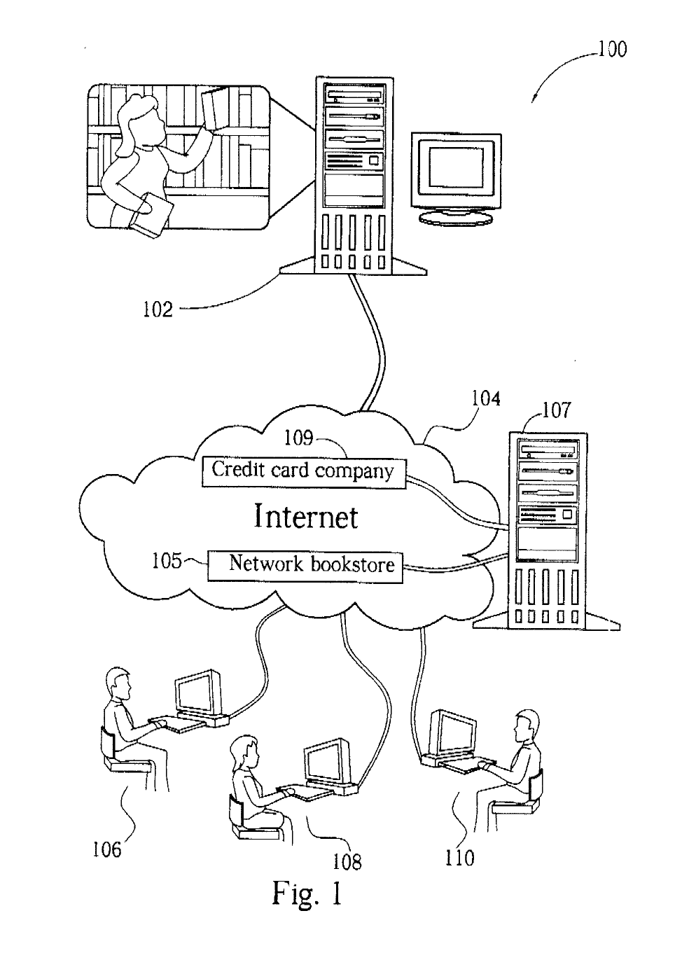

Please refer to FIG. 1, which is a diagram of an electronic document commerce system 100 according to the present invention. The electronic document commerce system 100 comprises a digital rights management server (DRM server) 102, an electronic document retail server 107 and terminals 106, 108 and 110. The terminals 106, 108 and 110 exchange information with both the DRM server 102 and the electronic document retail server 107 through a network 104, such as the Internet. The electronic document retail server 107 hosts an electronic document vendor, or so-called network bookstore 105, on the Internet 104, enabling users at the terminals 106, 108 or 110 to purchase a desired electronic document, electronic book, electronic news, or other electronic information from the network bookstore 105, The terminals 106, 108 or 110 may be a desktop computer, a notebook computer, a personal digital assistant (PDA), a WAP cellullar phone, etc. that can connect to the Internet 104 and transmit digital information.

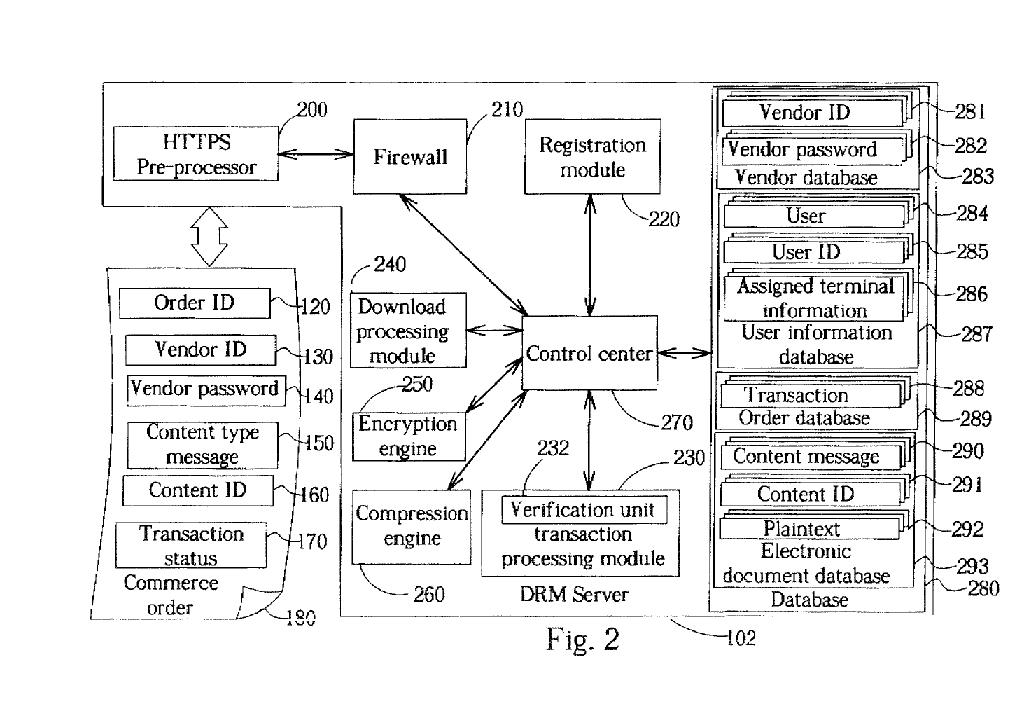

Please refer to FIG. 2, which is a functional block diagram of the digital rights management server 102 of the electronic document commerce system 100 according to the present invention. The digital rights management server 102 comprises an HTTPS pre-processor 200, a firewall 210, a registration module 220, a transaction processing module 230, a download processing module 240, an encryption engine 250, a compression engine 260, a control center 270, and a database 280.

Transaction security on a network is an important topic. For the time being, data transmission on the network utilizes encryption, and HTTPS is the major protocol for encrypted transmission. The HTTPS pre-processor 200 is used to perform an initial decryption procedure before the HTTPS encryption data enters into the DRM serve 102. The firewall 210 filters packages from the Internet 104, and allows certain registered internet services like telnet, e-mail, or FTP to connect to the Internet 104, and ensures both the configuration and information of the DRM server 102 are not compromised, i.e., hacked. The transaction processing module 230 registers a terminal assigned by a user so that the user becomes a legal registered user, the assigned terminal also becoming a legal terminal that may download electronic documents in a legal manner.

The transaction processing module 230 is used to process orders for electronic documents. The transaction processing module 230 comprises a verification unit 232 for verifying and confirming the contents and origins of orders. The download processing module 240 is used to perform procedures related to when a user downloads a desired electronic document. The encryption engine 250 is used to encrypt the plaintext of an electronic document, which can be later sent to the terminal of the user after completion of the process of purchasing the electronic document. The compression engine 260 performs a compression procedure to documents or data purchased by the user so as to reduce transmission bandwidth of the data, and thus shorten the transmission time.

The database 280 comprises as least four sub databases, a vendor database 283, a user information database 287, an order database 289, and an electronic document database 293. The vendor database 283 stores information related to contracted electronic document vendors (i.e., vendors under contract). Such information includes a vendor ID 281, and a vendor password 282. The user information database 297 stories information about users 284, the corresponding IDs 285 of users 284, and fundamental information of assigned terminals 286. The order database 289 stores each transaction 288, serving as an electronic receipt of sorts. The electronic document database 293 stores plaintext 292 of the electronic documents, and a corresponding content ID 291. The content ID 291 enables the database 280 to perform a cross-checking and filing process for an electronic book or electronic document, and has a corresponding content type message 290 of the electronic document. The control center 270 is used to control operations of the DRM server 102, and to process each module, engine (or database of the DRM server 102.

The purchasing method for the electronic document commerce system 100 comprises a registration procedure, a purchasing procedure, and a download procedure, which are discussed below.

The objective of the registration procedure is to enable a user to become a legal purchaser by registering with, the DRM server 102. In hand, the registration procedure also enables a terminal 106 of the user, used to download electronic documents, to become a legal terminal. In the registration procedure, a user connects to the Internet 104 to download a reading application program into the terminal 106 for authorization by the DRM server 102 of a legal user and a legal terminal. Then, the DRM server 102 generates an ID code for the legal user, and sends the ID code across the Internet 104 to be stored in the now-legal terminal 106.

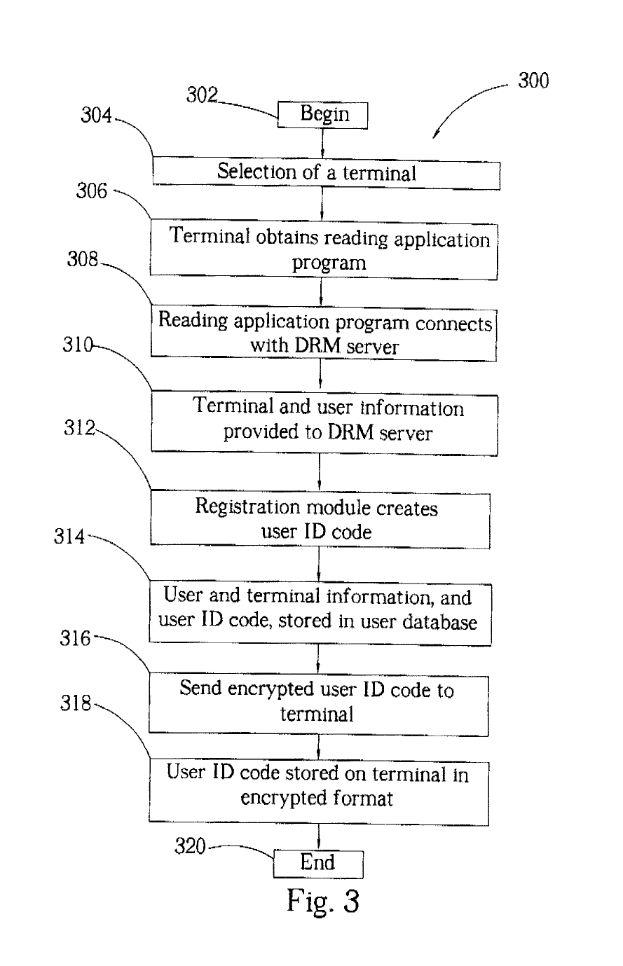

Please refer to FIG. 3, which is a flow diagram 300 of the electronic document commerce system when performing a registration procedure according to the present invention.

Step 302: Begin.

Step 304: Select a terminal 106 with which to perform the registration procedure.

Step 306: Uploading a reading application program to the selected terminal 106 from the Internet 104.

Step 308: The reading application program of the terminal 106 connects to the DRM server 102 to perform the registration procedure.

Step 310: Information 284 of the user, and information 286 of the terminal 106, are provided to the DRM server 102.

Step 312: The registration module 220 completes the registration procedure and generates a user ID code 285.

Step 314: User information 284, associated user ID code 285, and the terminal information 286 of the terminal 106 are stored in the user database 287.

Step 316: The user ID code 285 is encrypted and sent to the terminal 106.

Step 318: The reading application program of the terminal 106 stores the user ID code 285 on a hard drive of the terminal 106 in an encrypted format.

Step 320: End.

After completing the registration procedure, the user enters a purchasing procedure for an electronic document or documents. The user utilizes the terminal 106 to connect to the Internet 104 and to purchase a desired electronic document from the network bookstore 105 provided by the electronic document retail server 107 of the Internet 104. When the desired electronic document is found, the user requests the electronic document retail server 107 to perform the transaction for the electronic document, and provides information required for the transaction. The required information for the transaction includes an ID of the user, a desired electronic document to purchase, a type of payment (such as a credit card payment), and payment information (such as a credit card number). The required information for the transaction is filled into columns, which are designed into web pages of the network bookstore 105.

After the user provides the required information, the electronic document retail server 107 first certifies the credit card information with a certification authority (CA) 109 of a credit card company, and the certification authority sends a transaction status message referring to a certification result to the electronic document retail server 107. When the credit card information, certified by the certification authority 109, is correct and effective, the contents of the transaction status message will include a confirmation message, and so the transaction procedure continues. When the credit card information certified by the certification authority 109 is incorrect or overdue, the contents of the transaction status message will include an error message, in which case the electronic document retail server 107 rejects the order and stops the transaction procedure.

After completing the certification of the transaction payment, the electronic document retail server 107 uses the related information of the electronic document to generate a commerce order 180. The commerce order 180 comprises information about an order ID 120, a vendor ID 130, a vendor password 140, a content-type message 150, a content ID 160 of the user-required electronic document, and the transaction status message 170, The order ID 120 serves to uniquely identity the respective transaction. When a vendor or a network bookstore signs a contract with the DRM server 102 to join the system of purchasing or renting electronic documents, the DRM server 102 provides a unique vendor ID 130 and vendor password 140 to the vendor so that the DRM server 102 is capable of distinguishing different vendors from the respective vendor ID 130 and the vendor password 140. The DRM server 102 stores various types of electronic documents, such as electronic books, electronic news or electronic information, and so the content-type message 150 is used to provide a description of the type of electronic document being ordered. The electronic document retail server 107 also includes the content ID 160 of the user-requested electronic document in the commerce order 180, and the transaction status message 170 obtained from the certification authority 109. The electronic document retail server 107 then transmits the commerce order 180 to the DRM server 102 to under go the next step of the transaction procedure.

The commerce order 180 transmitted from the electronic document retail server 107 to the DRM server 102 does not contain an ID of the user. For electronic commerce on the Internet 104, a name list of clients confidential information, having extra commercial value, so the name list of clients should not be leaked to another company. In the transaction procedure of the present invention, although the commerce order 180 received by the DRM server 102 does not comprise the ID of the user, this has no adverse affect on the following downloading procedure for an electronic document.

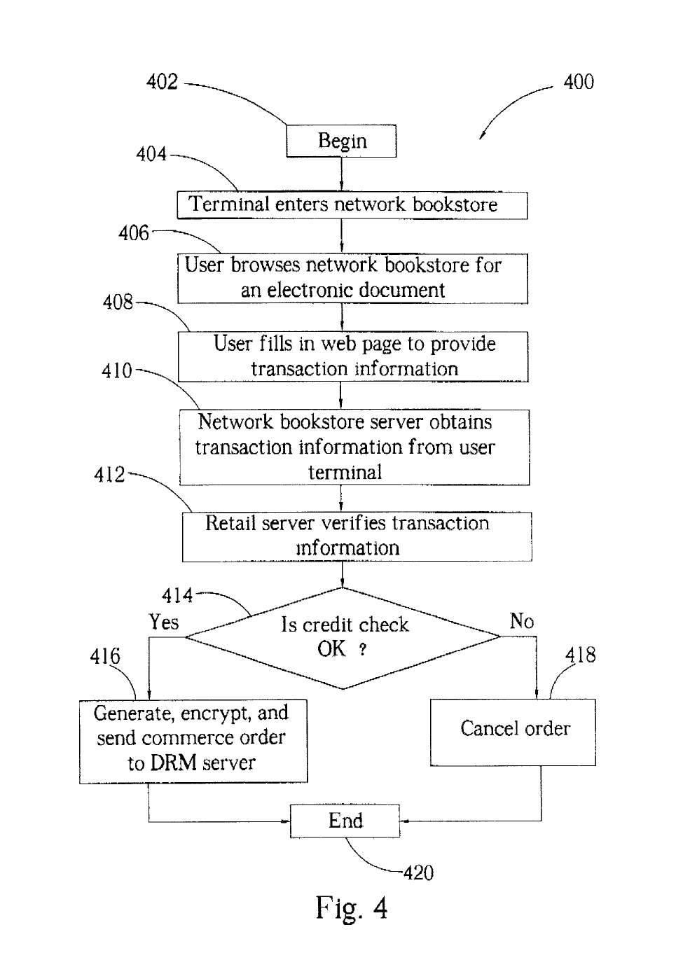

Please refer to FIG. 4, which is a flow diagram 400 of the electronic document commerce system 100 before a commerce order 180 according to the present invention has been generated.

Step 402: Begin.

Step 404: Utilize the terminal 106 to connect to the Internet 104 and enter a website of a network bookstore 105.

Step 406: The user browses the website of the network bookstore 105, and decides to purchase an electronic document.

Step 408: Information required for a transaction, such as the name of the user, the desired electronic document to purchase, and credit card information, is provided by the user.

Step 410: The above transaction information is sent to the electronic document retail server 107 of the nest bookstore 105.

Step 412: The electronic document retail server 107 performs a credit check, requiring certification of the credit card information, from a certification authority 109.

Step 414: If the certification authority 109 properly certifies the credit card information, then proceed to step 416. Otherwise, proceed to step 418.

Step 416: The electronic document retail server 107 encrypts the commerce order 180 and transmits the commerce order 180 to the DRM server 102.

Step 418: Halt the transaction, canceling the order.

Step 420: End.

When the DRM server 102 receives the commerce order 180, the HTTPS pre-processor 200 analyzes the commerce order 180 to perform some pre-processing. The HTTPS pre-processor 200 first decrypts the encrypted order 180 to obtain the transaction information. As discussed earlier, the commerce order 180 has information about the order ID 120, the vendor ID 130, the vendor password 140, the content type message 150, the content ID 160 of the user-requested electronic document, and the transaction status message 170. The HTTPS pre-processor 200 extracts the transaction information related to the order when the order is transmitted, and then transmits the extracted transaction information to the control center 270 through the firewall 103. The control center 270 receives this transaction information and transmits the information to the transaction processing module 230, which performs the procedures related to transacting the purchase of the electronic document. The transaction processing module 230 comprises a verification unit 232 for verifying the information corresponding to the order 180. When the transaction processing module 230 receivers the commerce order 180 transmitted from the control center 270, the verification unit 232 begins to a verification procedure with the corresponding information.

The verification unit 232 verifies the transaction status message 170 of the commerce order 180, and confirms that the certification authority 109 has truly accepted the transaction payment. When confirmed, the transaction procedure is considered completed, and the processing module 230 is so notified. After verification by the processing module 230, the control center 270 sends a verification message to the electronic document retail server 107 of the net bookstore 105. In response, the electronic document retail server 107 sends a notification to the reading application program of the terminal, indicating that the terminal should display a download picture so that the user can know and begin to download the desired electronic document. The verification message received by the electronic document retail server 107 further comprises the ID code 160 of the desired electronic document so as to enable the electronic document retail server 107 to access the correct electronic document during the download procedure.

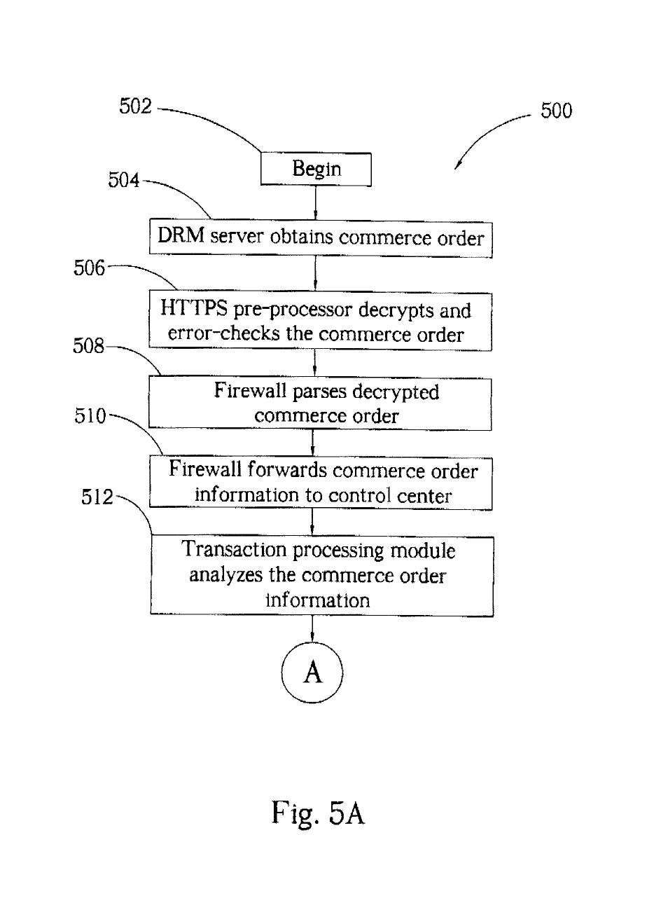

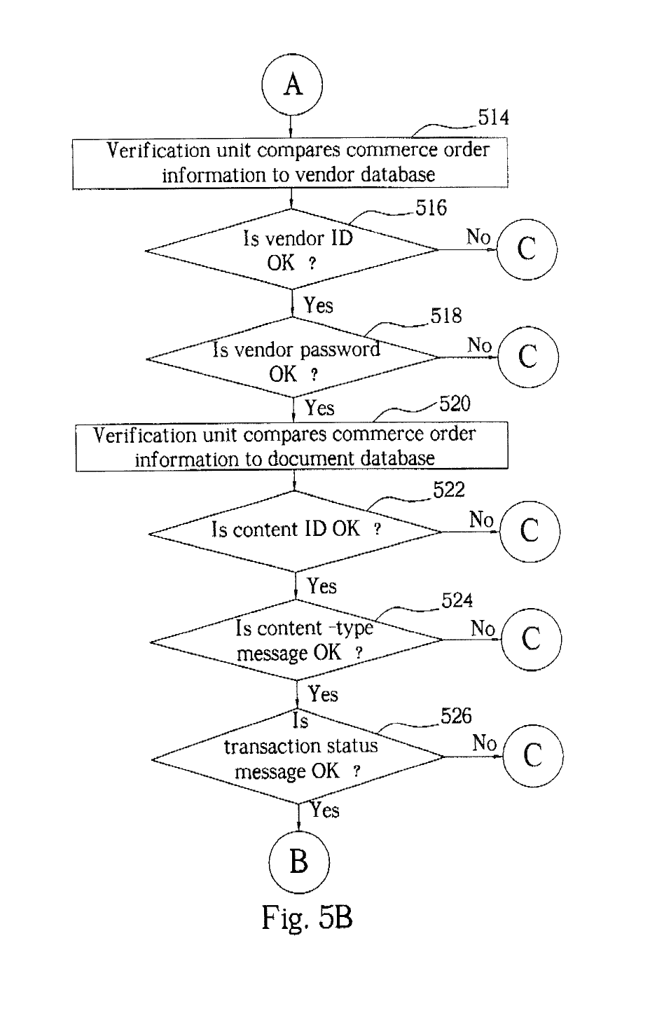

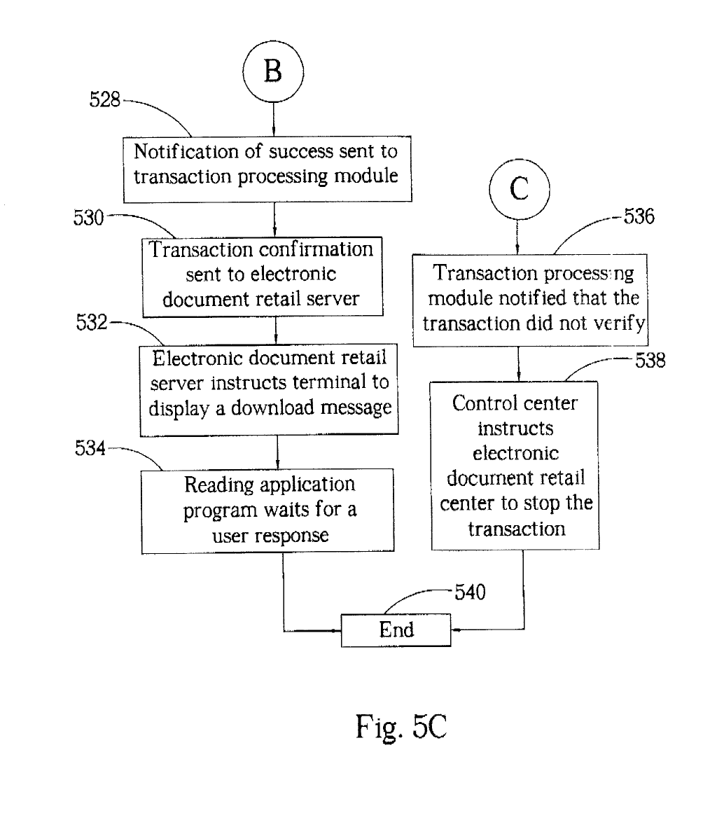

Please refer to FIG. 5, which is a flow diagram 500 of the digital rights management server 102 after receiving the commerce order 180 according to the present invention.

Step 502: Begin

Step 504: The DRM server 102 receives the commerce order

Step 506: The HTTPS pre-processor 200 decrypts the commerce order 180 and ensures that the transmission of the commerce order 180 was error-free.

Step 508: The firewall 210 examines information in the decrypted order 180.

Step 510: The information in the commerce order 180 is transmitted to the control center 270.

Step 512: The transaction processing module 230 processes the information in the commerce order 180, as received from the control center 270.

Step 514: The verification unit 232 utilizes the vendor database 283 to verify the accuracy of the information of the commerce order 180.

Step 516: If the vendor ID 130 is verified according so the vendor database 283, proceed to step 518. Otherwise, proceed to step 536.

Step 518: If the vendor password 140 verifies with the vendor database 283, the proceed to step 520. Otherwise, proceed to step 536.

Step 520: The verification unit 232 utilizes the electronic document database 293 to verify the accuracy of the information of the commerce order 180.

Step 522: If the content ID 160 verifies with the electronic document database 293, then proceed to step 524. Otherwise, proceed to step 536.

Step 524: If the the content-typo message 150 verifies with the electronic document database 293, then proceed to step 526. Otherwise, proceed to step 536.

Step 526: The verification unit 232 verifies the accuracy of the transaction status message 170. If transaction status message 170 is fine, then proceed to step 528. Otherwise, proceed to step 536.

Step 528: The verification unit 232 notifies the transaction processing module 230 that the transaction has been successfully verified.

Step 530: The transaction processing module 230 sends a verification message to the electronic document retail server 107 through the control center 270, indicating that the transaction may proceed.

Step 532: The electronic document retail server 107 sends a message to the reading application program of the terminal to show the download picture.

Step 534: The reading application program of the terminal waits for a response from the user.

Step 536: The verification unit 232 sends a notice to the transaction processing module 230 that the transaction did not verify.

Step 538: The control center 270 sends a notice to the electronic document retail server 107 to stop the transaction.

Step 540: End.

When the user initiates the download, say, by pushing a button, the download procedure of the electronic document begins. The reading application program of the terminal 106 first establishes a connection with the DRM 102, then transmits the user ID generated and stored in the terminal 106 with the content ID 160 to the download processing module 240 of the DRM server 102. When the download processing module 240 receives the user ID, the download processing module 240 utilizes the information 284 of the user and the information 286 of the terminal 106 in the user database 287 to find the corresponding user and terminal. The encryption engine 250 encrypts the plaintext 292 of the desired electronic document to form a corresponding ciphertext from the electronic document database 293. The compression engine 260 the compresses this corresponding ciphertext to reduce the total size of the information to be transmitted. Finally, the compressed ciphertext is transmitted to the terminal 106 through the Internet 104, thus completing the download procedure for the electronic document.

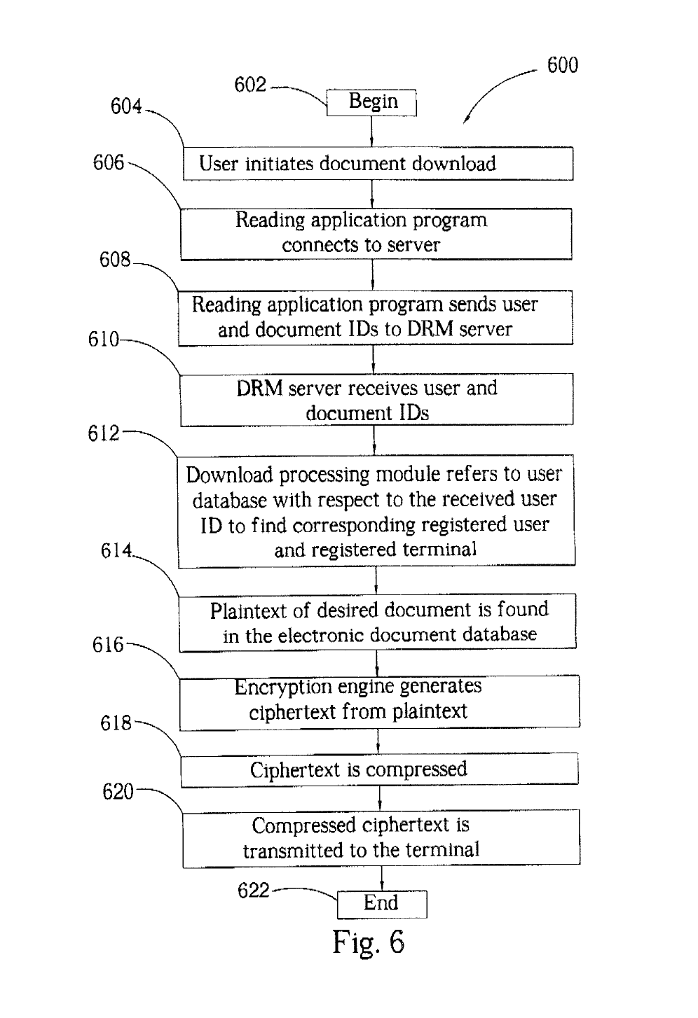

Please refer to FIG. 6, which is a flow diagram 600 for the electronic document commerce system 100 when downloading an electronic document according to the present invention

Step 602: Begin.

Step 604: The user presses a button to begin downloading the desired document.

Step 606: The reading application program of the terminal 106 establishes a connection with the DRM server 102.

Step 608: The reading application program of the terminal 106 transmits the user ID, as well as the content ID 160 of the desired electronic document, to the DRM server 102.

Step 610: The DRM server 102 receives the user ID and the content ID 160.

Step 612: The download processing module 240 utilizes the user database 287 and the received user ID to find the corresponding user and terminal.

Step 614: The download processing module 240 uses the electronic document database 293 to search for the plaintext 292 of the desired electronic document.

Step 616: The encryption engine 250 encrypts the plaintext 292 of the desired electronic document to form the corresponding ciphertext.

Step 618: The compression engine 260 compresses the ciphertext.

Step 620 The compressed ciphertext is transmitted to the terminal 106.

Step 622: End.

In contrast to the prior art, the electronic document retail server 107 of the present invention electronic document commerce system 100 transmits the commerce order 180, without including the user ID, to the DRM server 102, the lack of a user ID not affecting the subsequent downloading procedure of the electronic document.

The above disclosure is not intended as limiting. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for purchasing an electronic document in a network using a digital rights management server (DRM server) to exchange information with at least one electronic document retail server and at least one terminal, the terminal exchanging information with both the DRM server and the electronic document retail server, the method comprising a registration procedure and a purchasing procedure, the registration procedure comprising:
a) loading a reading application program in the terminal for authorization by the DRM server of a legal user and a legal terminal;
b) the DRM server generating an ID code for the legal user and sending the ID code to be stored in the legal terminal; the purchasing procedure comprising:
c) sending a request for a desired electronic document from the terminal to the electronic document retail server, the request comprising information corresponding to the ID code of the user, and information corresponding to the desired electronic document;
d) the electronic document retail server receiving the request from the user and then generating an order for the DRM server, the order comprising information corresponding to the electronic document without the ID code of the user;
e) the DRM server performing a checking procedure that utilizes the corresponding information of the order after receipt of the order by the DRM server; and
f) upon successful completion of the checking procedure, the DRM server sending a verification message to the user, enabling the user to begin a download procedure for downloading the electronic document to the terminal.

2. The method of claim 1 wherein the electronic documents an electronic book, electronic news, or electronic information.

3. The method of claim 1 wherein the DRM server sends an encrypted ID code of the user to the terminal, the legal terminal storing the encrypted ID code of the user in step (b) of the registration procedure.

4. The method of claim 1 wherein the information corresponding to the desired electronic document of step (c) comprises payment information.

5. The method of claim 4 wherein the payment information is user credit card information.

6. The method of claim 5 wherein the electronic document retail server first certifies the credit card information with a certification authority (CA) from a credit card company, and the certification authority sends a transaction status message referring to a certification result to the electronic document retail server.

7. The method of claim 6 wherein an order for the CA comprises information about an order ID, a vendor ID, a vendor password, a content type message, a content ID of the user-required electrical document, and the transaction status message.

8. The method of claim 7 wherein the DRM server comprises:
a vendor database for storing a plurality of vendor IDs and a plurality of corresponding vendor passwords; and
an electronic document database for storing a plurality of content IDs for corresponding electronic documents, plain text of electronic documents, and corresponding content-type messages.

9. The method of claim 8 wherein the DRM server further comprises:
a transaction processing module for processing an order from the electronic document retailing server; and
a control center for controlling operations of the DRM server.

10. The method of claim 9 wherein the transaction processing module comprises a checking unit for checking corresponding information of the order.

11. The method of claim 10 wherein the checking unit:
e1) verifies the validity of both a vendor ID and a vendor password using the vendor database;
e2) verifies the validity of both a content ID of an electronic document and a content-type message using the electronic document database;
e3) verifies a transaction status message and an authorization of payment information; and
e4) sends a verification message to the user.

12. The method of claim 1 wherein the DRM server comprises a user database to record information about all legal users, corresponding user IDs, and registered terminals.

13. The method of claim 12 wherein after receiving the verification message, the reading application program of the terminal displays a downloading image to inform the user of the ability to begin downloading, a downloading procedure beginning after the user responds to the downloading image.

14. The method of claim 13 wherein the downloading procedure comprises:
f1) the reading application program connecting to the DRM server after the user responds to the downloading image;
f2) the reading application program sending the user ID to the DRM server: and
f3) the DRM server using the user database to identify both the user corresponding to the user ID and the registered terminal in order to send the electronic document to the registered terminal for downloading.
